(19) United States
(12) Patent Application Publication
(10) Pub. No.: US 2006/0061045 A1
(43) Pub. Date: Mar. 23, 2006

(54) Gasket containing at least one rib incorporating a compression limiter

(75) Inventor: Jean Pascal Burg, Saint-Gence (FR)

Correspondence Address: HARNESS, DICKEY & PIERCE, P.L.C., P.O. BOX 828, BLOOMFIELD HILLS, MI, 48303, US

(73) Assignee: CARL FREUDENBERG KG

(21) Appl. No.: 11/218,051

(22) Filed: Sep. 1, 2005

(30) Foreign Application Priority Data
Sep. 21, 2004 (FR) FR 04 52104

(51) Int. Cl. F02F 11/00

(52) U.S. Cl. 277/593

(57) ABSTRACT

A gasket that can be incorporated between two surfaces to be sealed, the gasket containing at least one sheet with at least one rib which as seen in cross-section contains, on one hand, a central part that can come in contact directly or indirectly with one of the two surfaces to be sealed and, on the other hand, has legs disposed on both sides of the central part and which can directly or indirectly be in contact with the other surface to be sealed. The central part of the rib has at least one shape that acts as compression limiter.

### CROSS-REFERENCE TO RELATED APPLICATIONS

This application claims the benefit of French Patent Application 04 52104 filed Sep. 21, 2004. The disclosure of the above application is incorporated herein by reference in its entirety.

### FIELD OF THE INVENTION

The present invention relates to a gasket containing at least one rib incorporating a compression limiter, wherein the gasket is particularly intended for use as a cylinder head gasket.

### BACKGROUND OF THE INVENTION

A cylinder head gasket, disposed between an engine block and a cylinder head, generally contains one or more metallic sheets with openings capable of cooperating with the combustion chambers. The head gasket is also generally provided with orifices that permit the passage of fluids or tightening means such as threaded rods.

So-called dynamic cylinder head gaskets are capable of adapting themselves to variations in separation between the engine block and the cylinder head, particularly as a result of deformation-dilatation phenomena. Dynamic cylinder head gaskets are also capable of adapting themselves to geometric variations such as the state of the surface, parallelism, planarity, or other variations which are capable of varying from one engine block to another or from one cylinder head to another.

This type of gasket generally contains a rib that can surround the openings and/or orifices so as to form a sealing barrier. For purposes of the present description, the term “rib” is intended to be a profile having a cross-section with a central part which, by means of one or more elements, can be directly or indirectly in contact with a first surface to be sealed. Two legs are disposed on both sides of the central part that are capable of, by means of one or more elements, being in contact directly or indirectly with the second surface to be sealed. Generally, a rib has an omega-shaped profile. Notwithstanding, the central part can be curved or it can contain a linear portion. Also, the rib can extend longitudinally in a circular or noncircular manner depending on the zone to be sealed.

When the gasket is disposed between the engine block and the cylinder head, the rib is slightly compressed and deformed to adapt to the geometry of the various elements. Because of its elasticity, the rib can be deformed during operation to adapt itself to the variations of the distance e between the engine block and the cylinder head, while the central part maintains direct or indirect contact with the cylinder head, and the legs maintain direct or indirect contact with the engine block. Alternatively, the central part is in contact with either the engine block or the cylinder block.

To preserve the elasticity of the rib and to avoid reaching its plastic deformation during installation and operation, a compression limiter is generally provided adjacent to the rib. When interposed between the rib and an opening adapted to a combustion chamber, the limiter is referred to as a stopper.

In FIGS. 1 and 2 a prior art gasket 10 is shown which can be disposed between a first surface to be sealed 12 and a second surface to be sealed 14. The gasket 10 contains at least one rib 16 disposed in the vicinity of an opening 18. The central part of the rib is marked by reference numeral 20 and the legs by reference numeral 22.

As shown in FIG. 1, the gasket 10 contains a single sheet 24 in which is provided a rib 16, wherein the legs 22 of the rib are in contact with the first surface to be sealed 12. The central part 20 is in contact with the second surface to be sealed 14. To limit the compression of rib 16, the gasket 10 contains, interposed between the rib 16 and the opening 18 and adjacent to the rib 16, a stopper 26 in the form of, for example, a crease provided at the edge of the sheet delimiting the opening 18.

As shown in FIG. 2, the gasket 10 contains at least one sheet 28, referred to as an active sheet 28. Preferably, two sheets 28, each containing a rib 16 the central parts of which are oriented toward one another, and a sheet 30 interposed between the active sheets 28 and in contact with the central part of the rib 16 of the active sheet 28 are provided. The interposed sheet 30 supports a stopper 32 disposed adjacent to the rib or ribs 16 and is, for example, disposed from edge to edge with the interposed sheet 30 or in the form of a crease to delimit the opening, as illustrated in FIG. 2.

To obtain an approximately uniform distribution of compression stresses, the height h of the stopper 26 or 32 can vary longitudinally. To reduce fabrication costs while retaining excellent sealing, gaskets with a single sheet tend to be preferred.

Even in this case, however, one can see that providing a compression limiter generally presents problems and imposes additional costs.

Hence, the purpose of the present invention is to avoid the drawbacks of the prior art by proposing a novel gasket of simple design whereby fabrication costs can be reduced without affecting the sealing efficacy.

### SUMMARY OF THE INVENTION

To this end, an object of the present invention is to provide a gasket that can be incorporated between two surfaces to be sealed. The gasket contains at least one sheet with at least one rib which, as seen in cross-section, contains a central part that can come in contact directly or indirectly with one of the two surfaces to be sealed. Legs are disposed on both sides of the central part which directly or indirectly can be in contact with the other surface to be sealed. The central part of the rib has at least one shape that acts as a compression limiter.

By incorporating the compression limiter into the rib, these two elements can be fabricated in a single, simple step which makes it possible to optimize the fabrication process of such a gasket, and to reduce fabrication costs while retaining excellent sealing.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a cross-sectional view illustrating a gasket according to the prior art;

FIG. 2 shows a cross-sectional view illustrating another gasket of the prior art;

FIG. 3 shows a cross-sectional view of a gasket according to a principle of the invention interposed between two surfaces to be sealed;

FIG. 4 shows a cross-sectional view illustrating in detail the rib section of a gasket according to a principle of the present invention;

FIG. 5 is a top view of a part of a gasket according to a principle of the present invention;

FIGS. 6A to 6M show different variants of gaskets according to principles of the present invention; and

FIG. 7 shows a curve illustrating the deformations of a rib according to a principle of the present invention.

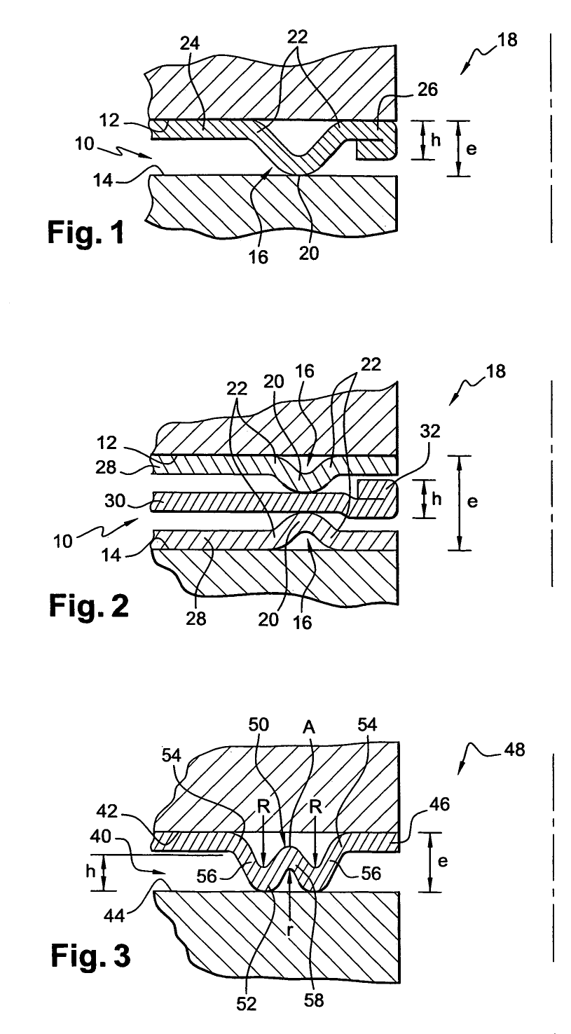

### DETAILED DESCRIPTION OF THE PREFERRED EMBODIMENTS

The following description of the preferred embodiment(s) is merely exemplary in nature and is in no way intended to limit the invention, its application, or uses.

Now referring to FIG. 3, a gasket 40 of the present invention is interposed between a first and a second surface to be sealed, for example, in the case of a cylinder head gasket, a cylinder head 42 and an engine block 44. Naturally, the invention is not limited to this application but, rather, covers all applications requiring an approximately flat gasket.

Depending on the case, the distance separating the two surfaces to be sealed 42 and 44, referred to as gap e, can vary during operation.

Gasket 40 contains at least one leaf or plate called sheet 46 which is preferably made of coated or uncoated metal.

The gasket 40 contains at least one opening and/or orifice 48 to allow communication between conduits ending respectively at each surface 42 or 44 to be sealed. In the case of a cylinder head gasket, the gasket 40 contains at least one opening 48 capable of cooperating with a combustion chamber and orifices permitting the passage of fluids or tightening means such threaded rods.

The gasket 40 contains at least one sealing barrier, preferably a dynamic one, in the form of a rib 50.

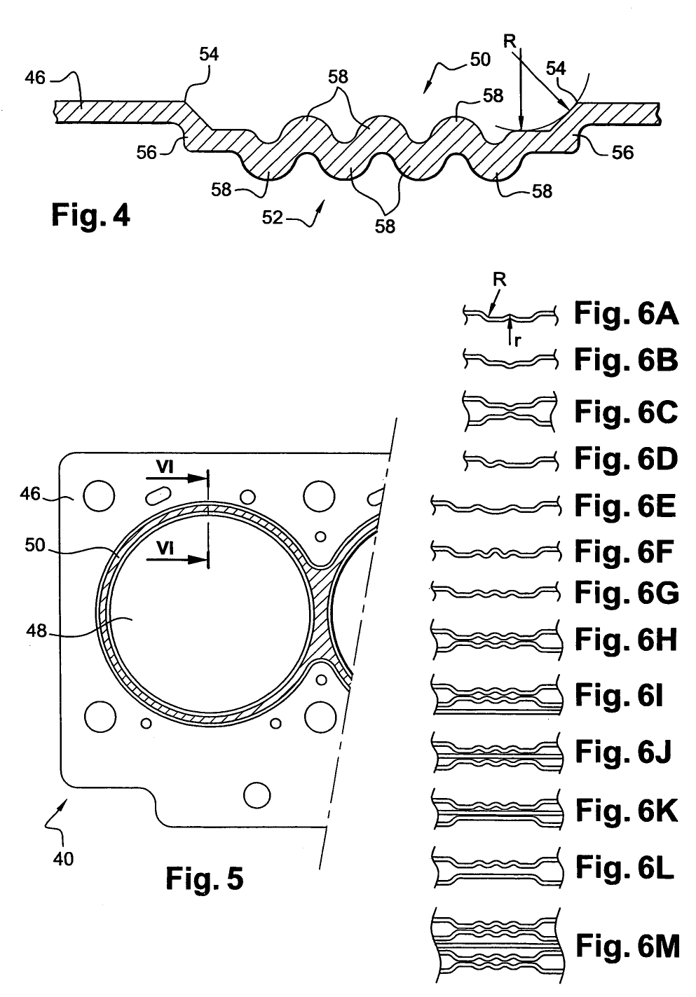

Depending on the case, rib 50 extends continuously or discontinuously in a circular or noncircular fashion. For example, rib 50 can surround an opening 48 provided for a combustion chamber as illustrated in FIG. 5. In this case, the rib 50 can be essentially circular and can be disposed at an approximately constant distance from the edge of the gasket 40 delimiting opening 48.

As can be seen in cross-section, rib 50 contains a central part 52 which, particularly during mounting, is in contact directly or indirectly with one of the surfaces 42 or 44 to be sealed. In this case, the central part 52 is in direct contact with engine block 44. Legs 54 are disposed on both sides of central part 52 and are capable of being in contact directly or indirectly with the other surface 42 or 44 to be sealed. In this case, the legs 54 are in direct contact with cylinder head gasket 42.

Gasket 40 is also provided with two inclined branches 56 that are each capable of linking central part 52 to one of legs 54. In addition, each leg 54 contains a straight portion linked to the remainder of sheet 46 and a curved portion linking the straight portion to one of branches 56 of the central part.

To preserve the elasticity of rib 50 and to limit its compression during the mounting and in operation, gasket 40 contains a compression limiter 580.

According to the present invention, rib 50, preferably the central part 52, contains a compression limiter 58. According to the present invention, the cross-section of central part 52 has at least one shape acting as compression limiter 58. To this end, as shown in FIG. 3, central part 52 contains at least one compression limiter 58 which, here, is in the form of a ridge 58. The invention is not limited to this shape, however, and the compression limiter 58 may possibly have the shape of a notch, a triangle, or the like. Furthermore, the central part 52 can have a combination of these shapes.

According to another characteristic of the present invention, the link between legs 54 and central part 52 of the rib can undergo elastic deformation to push peak A of the at least one ridge 58 against the surface to be sealed that is in contact with legs 54 of the rib 50, particularly during operation. This arrangement makes it possible to improve sealing, as each peak A forms a sealing barrier. Thus, during operation, peak or peaks A and the legs 54 of the rib 50 are in contact with a first surface to be sealed, whereas at least the zones linking branches 56 and central part 52 are in contact with the other surface to be sealed.

According to yet another characteristic of the present invention, the curvature radius R of a zone linking branches 56 and central part 52 is greater than the curvature radius r of the ridge or ridges 58. In this manner, curvature radius R facilitates elastic deformations whereas curvature radius r limits elastic deformations. This arrangement makes it possible to obtain a good compromise between the resistance to deformation, which prevents total compression of the rib, and the elasticity of the rib which ensures sealing.

By curvature radius is meant the real curvature as shown in FIG. 3 or an imaginary curvature corresponding to the imaginary circle tangential to two successive inclined faces as illustrated for curvature radius R in FIG. 4.

According to another variant of the present invention, central part 52 can contain a plurality of ridges 58, as shown in FIG. 4.

For example, the distance separating adjacent valleys and peaks of the ridges may vary by about 0.4 to 0.8 mm, and a height h may vary by about 0.04 to 0.15 mm, depending on the characteristics of the elements to be sealed.

According to another characteristic of the present invention, the resistance to compression of the compression limiter or the distribution of compressive stresses can be varied along rib 50 by adjusting the height and/or the number of ridges.

It is also possible to segment the compression limiter.

Depending on the variant, gasket 40 can contain one sheet 46 as illustrated in FIGS. 6A, 6B, 6D, 6E, 6F and 6G, two sheets as illustrated in FIGS. 6C, 6H and 6L, or more than two sheets 46 as shown in FIGS. 6I, 6J, 6K and 6M.

The ridges can be centered or not centered relative to the central part as shown in FIG. 6D.

The ridges can all be identical, or not as shown in FIG. 6F.

The ridge or ridges can be oriented toward a first direction as shown in FIG. 6A, or toward a second direction as shown in FIG. 6B.

Depending on the case, the curvature of the ridges can be more or less narrow, as shown in FIGS. 6E and 6G.

For the variants incorporating at least two sheets, the ribs are oriented or not oriented toward one another as shown in FIGS. 6C, 6H, 6I, 6J, 6K, 6L and 6M.

The ribbed sheets can contain ridges on each rib as shown in FIGS. 6C, 6H, 6I, 6J, and 6M or on only one rib as shown in FIGS. 6K and 6L.

Moreover, a flat sheet can be provided between the ribbed sheets as shown in FIGS. 6J and 6K or pushed against one of the ribbed sheets as shown in FIG. 6I.

Naturally, not all arrangements are represented here considering that they can be varied indefinitely.

According to a preferred embodiment, the profile of the rib incorporating the compression limiter is created in a single step, for example by stamping.

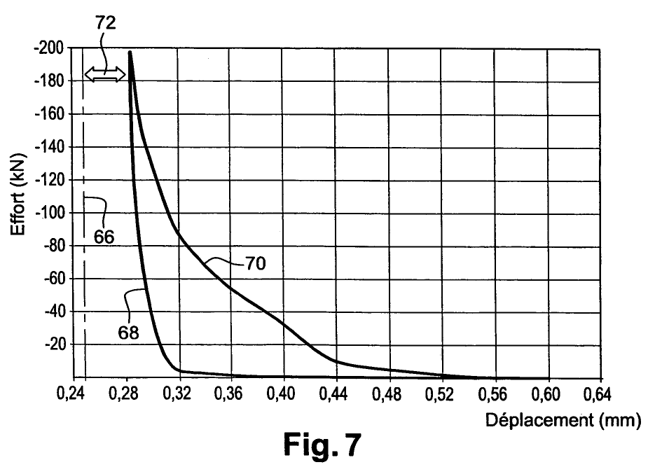

In FIG. 7 is shown an example of a compression test on a sheet containing a rib incorporating a compression limiter of the invention. This test was carried out on an approximately 0.25-mm thick sheet with a compression limiter with height h of about 0.05 mm.

This compression test was performed under a load of 200 KN, curve 66, namely a load greater than that which can be generated by normal tightening of the cylinder head to the engine block.

It can be seen that curve 68, which corresponds to the load discharging, is located above the thickness value of the sheet represented by 70 and that, thus, a stopping action is ensured by the present invention. This stopping value is graphically represented by two-way arrow 72.

Naturally, the invention is not limited to the design represented and described hereinabove, but on the contrary covers all variants, particularly those concerning the dimensions and shapes of the various elements.

Finally, the gaskets of the invention are not limited to the domain of cylinder head gaskets, but can be used in other applications.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A gasket that can be incorporated between two surfaces to be sealed, comprising:
at least one sheet including at least one rib including a central part which directly or indirectly contacts one of the surfaces to be sealed; and
a pair of legs disposed on either side of said central part which directly or indirectly contact the other surface to be sealed;
wherein said central part of said rib forms a shape that acts as a compression limiter.

2. The gasket according to claim 1, wherein a linking portion between said legs and said central part of said rib is elastically deformable to enable said compression limiter to be pushed against the surface to be sealed that is in contact with said legs of said rib.

3. The gasket according to claim 1, wherein said central part of said rib includes at least one ridge, at least one notch, and at least one shape that acts as said compression limiter.

4. The gasket according to claim 3, wherein said shape is triangular.

5. The gasket according to claim 3, wherein a zone that links branch portions of said sheet to said central part forms a curvature radius R that is greater than a curvature radius r of said ridge or ridges.

6. The gasket according to claim 1, wherein a height h of said compression limiter is in the range of 0.04 to 0.15 mm.

7. The gasket according to claim 3, wherein a height and/or a number of said ridges can vary along a length of said rib.

8. The gasket according to claim 1, wherein said compression limiter is segmented.

9. A gasket comprising:
at least one sheet interposed between a first surface and a second surface to be sealed;
said sheet including a pair of legs in contact with a first surface, and a contact portion in contact with a second surface, said contract portion including a plurality of linking portions that link said contact portion to said legs, said linking portions forming a plurality of ridges in said sheet that act as a compression limiter between said surfaces to be sealed;
wherein at least one ridge of said contact portion is in contact with said second surface.

10. The gasket according to claim 9, wherein linking portions of said contact portion that form a plurality of ridges form a W shape.

11. The gasket according to claim 9, wherein said linking portions of said contact portion that form a plurality of ridges form a wave shape.

12. The gasket according to claim 9, wherein a height of said ridges is less than a distance that separates said first and second surfaces to be sealed.

13. The gasket according to claim 9, wherein said contact surface is an elastically deformable contact surface.

14. A gasket comprising:
a plurality of sheets interposed between a first surface and a second surface to be sealed;
at least one of said plurality of sheets including a pair of legs in contact with a first surface, and a contact portion in contact with at least one of other sheets, said contract portion including a plurality of linking portions that link said contact portion to said legs, and said linking portions forming a plurality of ridges in said one sheet that act as a compression limiter between at least said first or second surface to be sealed and another of said plurality of sheets;
wherein at least one ridge of said contact portion is in contact with said another of said plurality of sheets.

15. The gasket according to claim 14, wherein a plurality of said sheets include a plurality of ridges.

16. The gasket according to claim 15, wherein said plurality of ridges of said plurality of sheets face each other.

17. The gasket according to claim 16, wherein said plurality of ridges of plurality of sheets that face each other are separated by a flat sheet interposed said ridges.

18. The gasket according to claim 14, wherein said contact portion is elastically deformable.
